(19) United States
(12) Patent Application Publication
(10) Pub. No.: US 2013/0344214 A1
(43) Pub. Date: Dec. 26, 2013

(54) OVEN EQUIPPED WITH A DETACHABLE STEAM DEVICE AND BAKING METHOD THEREOF

(71) Applicant: ENDAHRIC SB INTERNATIONAL COMPANY, LTD., (US)

(72) Inventor: CHAO-HSIANG TONG, Tainan City (TW)

(73) Assignee: ENDAHRIC SB INTERNATIONAL COMPANY, LTD., Tainan City (TW)

(21) Appl. No.: 13/890,887

(22) Filed: May 9, 2013

(30) Foreign Application Priority Data
Jun. 25, 2012 (TW) 101122612

(51) Int. Cl. A21B 3/04

(52) U.S. Cl. CPC A21B 3/04
USPC 426/511; 99/403

(57) ABSTRACT

An oven equipped with a detachable steam device includes an electric connecting portion. The steam device includes a body which has a water reservoir, a heater, a power cord and a steam ejection head. The water reservoir is connected to the heater. The power cord is electrically connected to the electric connecting portion. The steam ejection head is connected to and communicates with the water reservoir. Hence high temperature steam can be sprayed timely at a desired amount onto the surface of foodstuffs located outside or inside the oven through the steam ejection head, and the foodstuffs with varying sizes or characteristics can be baked at the same time to improve baking convenience and practicality and also make the baked foodstuffs more tasty.

### FIELD OF THE INVENTION

The present invention relates to an oven and a baking method thereof and particularly to an oven equipped with a detachable steam device and a baking method thereof.

### BACKGROUND OF THE INVENTION

It is commonly known that during baking foods with an oven providing a suitable amount of steam can make the food more tasty. The general professional steam oven has steam venting orifices in the chamber of the oven. During baking foods such as a dough, a built-in steam module can be electrically activated by pushing a button so that steam can be sprayed onto the surface of the food to allow the surface of the food to be gelatinized, thereby a crispy crust can be formed on the baked food. The steam also can increase moisture content of the food surface to prevent the baked food from forming hard or charred crust while the interior of the food is still not well cooked.

Some conventional ovens have auxiliary devices such as air fans to evenly spray steam onto the surfaces of different types of foods for baking at the same time. But the steam is ejected into the chamber through fixed venting orifices and cannot spray the steam to individual foods. They still leave a lot to be desired when more than one type of foods are needed to be baked at the same time.

For instance, baking bread to have crispy crust requires a small amount of steam sprayed thereon at the initial stage. But baking a chunk of frozen meat needs a great amount of steam to be sprayed thereon continuously or intermittently throughout the baking duration. Spraying the high temperature steam onto the meat surface can prevent the surface from being charred while the interior still not thawing. However, if a fermented dough also is baked at the same time, the high density steam in the chamber of the oven could make the dough absorb too much moisture and result in non-crispy crust. Thus providing an apparatus with adjustable and controllable steam density for individual food can save baking time and improve baking convenience and make the food more tasty.

### SUMMARY OF THE INVENTION

The primary object of the present invention is to overcome the disadvantage of the conventional steam oven that can only spray steam in the entire chamber to result in constraint on the baking time. The invention provides an oven equipped with a detachable steam device to shorten baking time and improve baking usability and flexibility.

To achieve the foregoing object, the oven according to the invention includes an electric connecting portion. The steam device includes a body which has a water reservoir, a heater, a power cord and a steam ejection head. The water reservoir is connected to the heater which heats the water in the water reservoir to become high temperature steam. The power cord has one end electrically connected to the body and another end coupled with a plug to connect electrically with the electric connecting portion. The steam ejection head is connected to and communicates with the water reservoir to eject the high temperature steam.

In one aspect the steam ejection head includes a tube and a nozzle. The tube has one end connected to the nozzle and another end connected to the body.

In another aspect the body includes a fast-coupling connector with an annular washer held on the inner wall. The tube of the steam ejection head is inserted into the fast-coupling connector to form tight coupling with the annular washer.

In yet another aspect the tube has at least one rigid section and at least one elastic section to spray steam all around.

In yet another aspect the body includes an automatic cord winding member inside to wind a portion of the power cord and retract the power cord inside the body.

Another object of the invention is to provide a baking method for an oven equipped with a detachable steam device. The method comprises the steps as follows: spraying steam for a first time onto the surface of a first foodstuff located outside the oven through the steam device electrically connected to the oven; loading immediately the steam-sprayed first foodstuff into the chamber of the oven; and baking the first foodstuff by starting the oven.

The baking method of the invention can further include another step of spraying steam for a second time onto the surface of a second foodstuff located outside the oven through the steam device electrically connected to the oven between the steps of spraying steam for a first time and loading the steam-sprayed first foodstuff.

Yet another object of the invention is to provide another baking method for an oven equipped with a detachable steam device. The method comprises the steps as follows: first, loading a first foodstuff into a chamber of the oven.; next, baking the first foodstuff by starting the oven; and spraying the steam onto the surface of the first foodstuff for at least a set duration through the steam device electrically connected to the oven while the first foodstuff is baked in the oven.

The baking method set forth above can further include the following steps: spraying the steam onto the surface of a second foodstuff located outside the oven through the steam device electrically connected to the oven; next, loading immediately the steam-sprayed second foodstuff into the chamber; and baking continuously for a selected duration and spraying the steam onto the surface of the second foodstuff at the same time for at least a set duration through the steam device electrically connected to the oven.

By means of the technique set forth above, compared with the conventional techniques, the invention can provide many advantages, notably: users can spray steam onto individual foodstuff located inside or outside the oven before or during baking process according to their baking preferences and experiences, hence can bake foodstuffs with varying sizes or characteristics at the same time to save total baking time, thereby improve baking convenience and flexibility, and also make the baked foodstuffs more tasty.

The foregoing, as well as additional objects, features and advantages of the invention will be more readily apparent from the following detailed description, which proceeds with reference to the accompanying drawings.

### BRIEF DESCRIPTION OF THE DRAWING,

FIG. 1 is a schematic view of an embodiment of the invention.

FIG. 2 is a schematic view of an embodiment of the invention in a use condition.

FIG. 3 is a schematic view of a first embodiment of the invention.

FIG. 4 is a schematic view of the first embodiment of the invention in a use condition.

FIG. 5 is a schematic view of the first embodiment of the invention in another use condition.

FIG. 6 is a schematic view of a second embodiment of the invention.

FIG. 7 is a flowchart of an embodiment of the baking method of the invention.

### DETAILED DESCRIPTION OF THE PREFERRED EMBODIMENTS

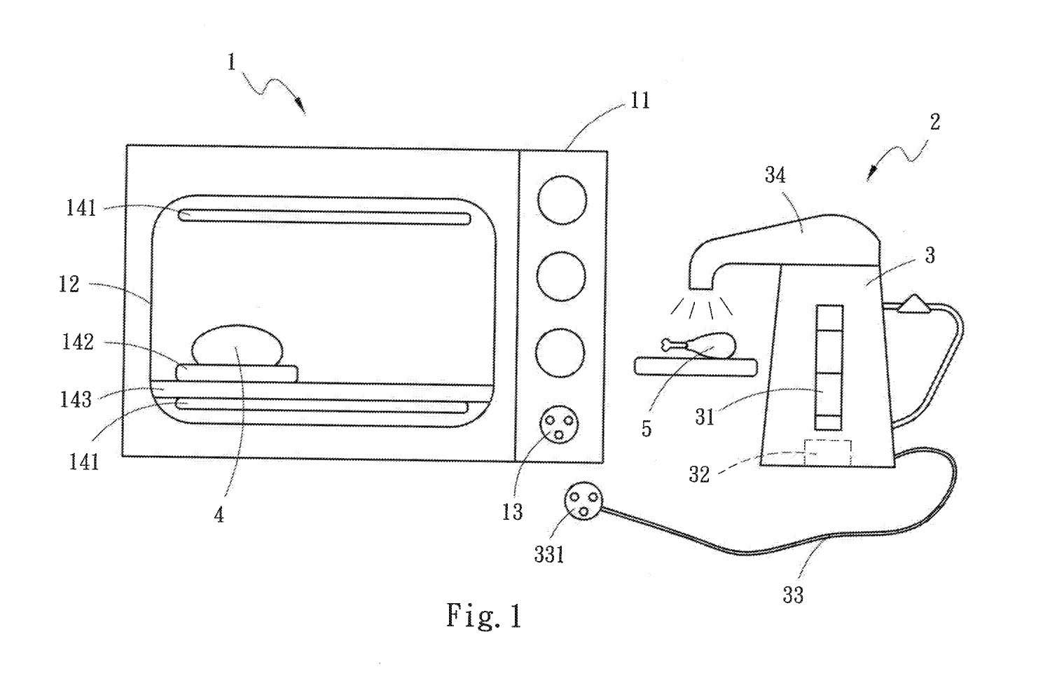

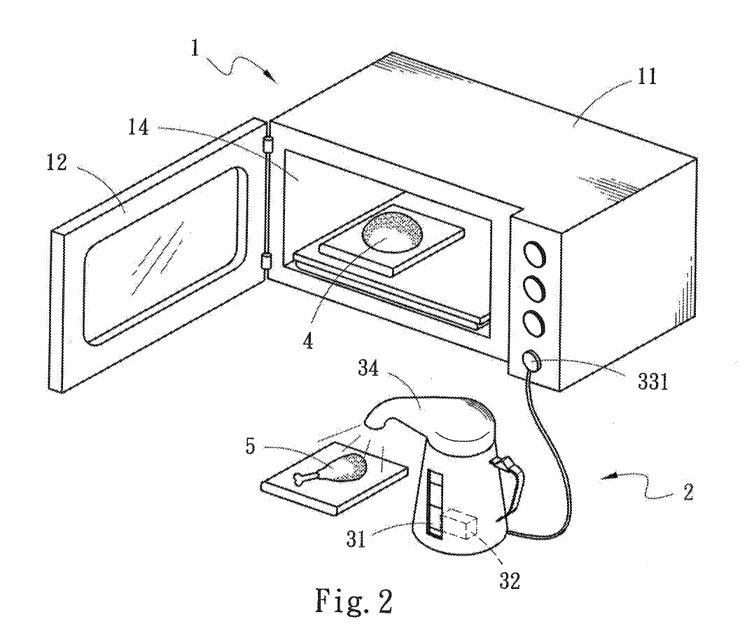

Please refer to FIGS. 1 and 2 for an embodiment of the invention. It provides an oven equipped with a detachable steam device 2. The oven 1 includes a heat isolation case 11 and a glass door 12. The heat isolation case 11 has an electric connecting portion 13 at an outer side that can be formed in a socket fashion with a fuse inside (not shown in the drawings) to provide safety when in use. The electric connecting portion 13 provides electric power for the steam device 2. The heat isolation case 11 has a chamber 14 inside and heating elements 141 at the top and bottom of the chamber 14. The chamber 14 also houses at least one baking tray 142 mounted on a movable rack 143 which is adjustable in elevation for holding foods.

The steam device 2 includes a body 3 which comprises a water reservoir 31, a heater 32, a power cord 33 and a steam ejection head 34. The water reservoir 31 is connected to the heater 32 which heats the water in the water reservoir 31 to become high temperature steam. The power cord 33 has one end electrically connected to the body 3 and another end coupled with a plug 331 to form electric connection with the electric connecting portion 13. The steam ejection head 34 is connected to and communicates with the water reservoir 31 to eject the high temperature steam.

When the invention is in use, the power cord 33 of the steam device 2 is electrically connected to the electric connecting portion 13 of the oven 1 so that the heater 32 is activated to heat the water in the water reservoir 31 to generate the high temperature steam. The steam is ejected through the steam ejection head 34. In the event that multiple types of foodstuffs are to be baked at the same time, such as a dough 4 and a frozen chicken leg 5 shown in FIG. 1, users can spray the steam onto individual foodstuffs before or during baking to maintain the humidity of the foodstuff surface as desired, thereby prevent the foodstuff surface from becoming dry and hard or charred while the interior of the foodstuff is still not well cooked. Hence baking flexibility and convenience improve, and the baked foodstuff also is more tasty.

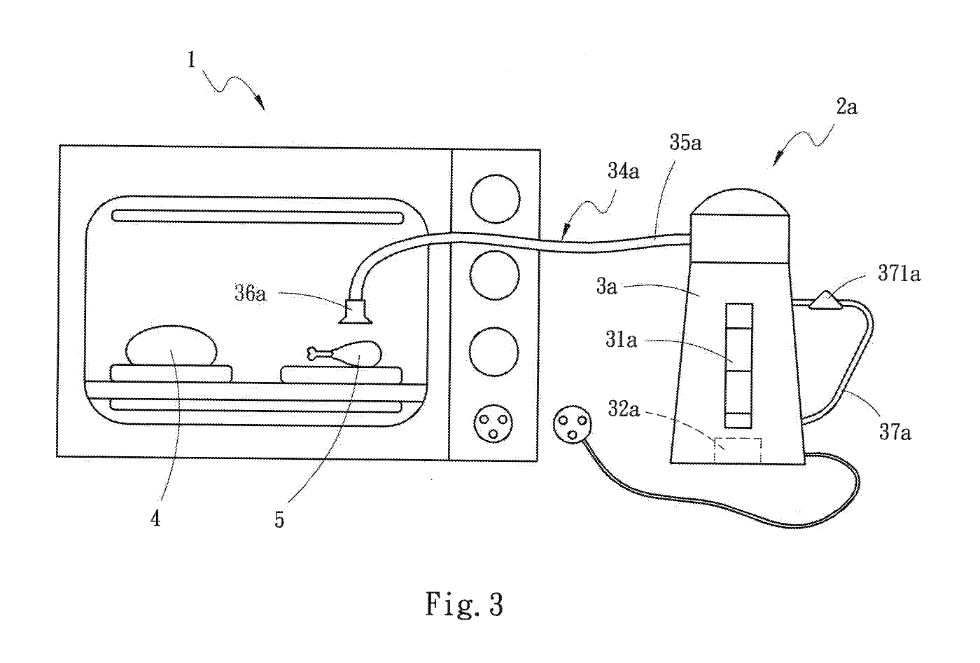

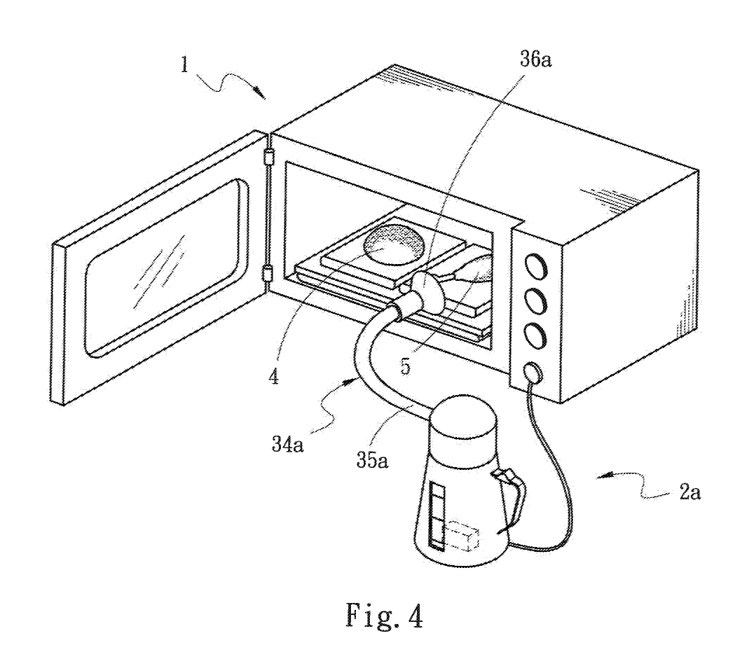

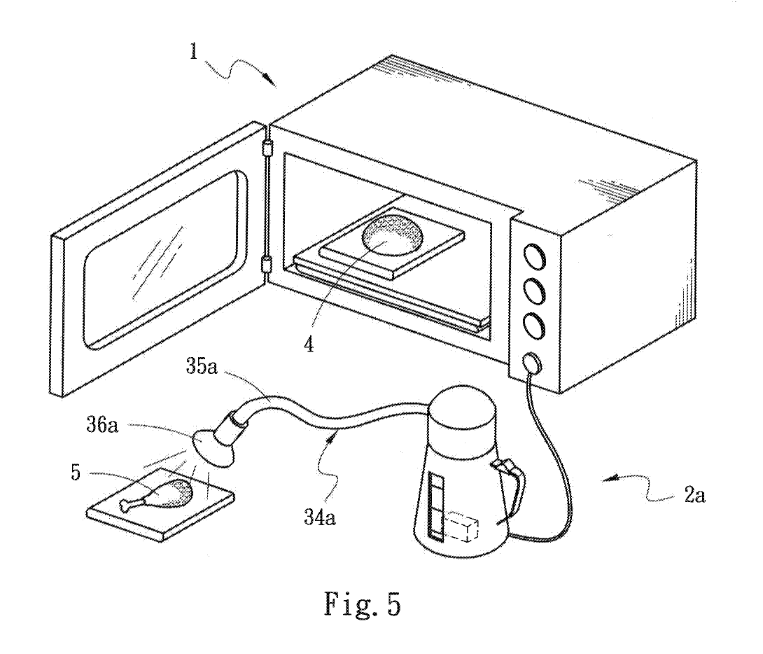

Please refer to FIGS. 3, 4 and 5 for a first embodiment of the invention. It includes an oven 1 and a steam device 2a. The steam device 2a has a body 3a which includes a steam ejection head 34a with a tube 35a and a nozzle 36a. The tube 35a has one end connected to the nozzle 36a and another end connected to the body 3a and communicating with the water reservoir 31a to receive the high temperature steam generated by heating of the heater 32a. The high temperature steam can be ejected through the nozzle 36a. The body 3a further has a handgrip 37a and a power switch 371a to facilitate gripping and activation of the body 3a by the user.

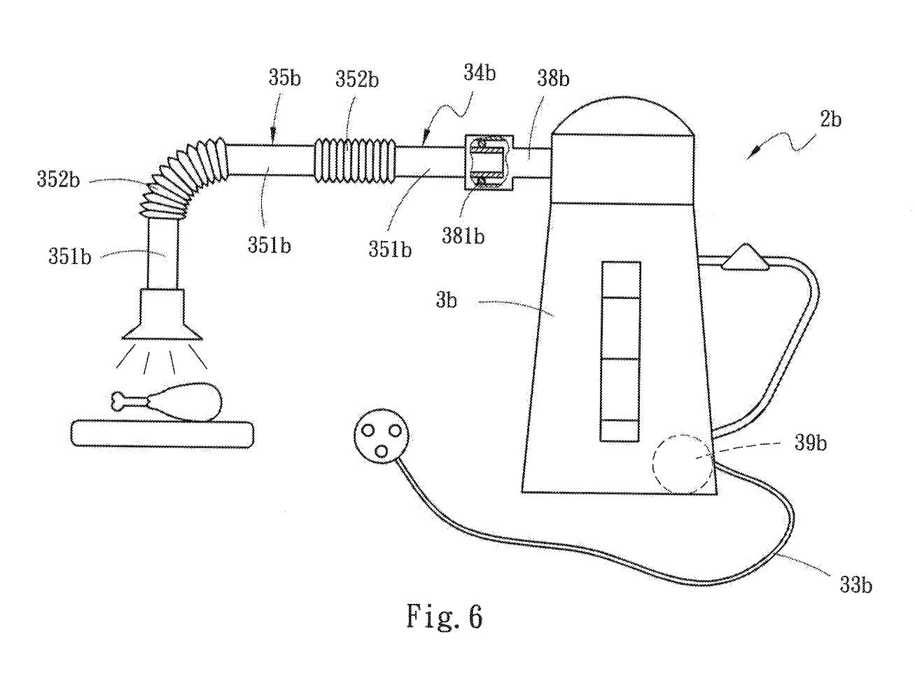

Please refer to FIG. 6 for a second embodiment of the invention. It provides a fast-coupling connector 38b on the body 3b of the steam device 2b. The fast-coupling connector 38b has an annular washer 381b inside to avoid the steam from leaking out. The steam ejection head 34b has a tube 35b inserted into the fast-coupling connector 38b to form tight coupling with the annular washer 381b. The tube 35b includes at least one rigid section 351b which is straight and hard and at least one elastic section 352b which is bendable easily. Such a design allows users to change the steam ejection head 34b easily as desired. Through the elastic section 352b, the steam can be sprayed all around to improve baking usability and practicality. In addition, the body 3b can further include an automatic cord winding member 39b to wind a portion of the power cord 33b so that the power cord 33b can be retracted inside the body 3b.

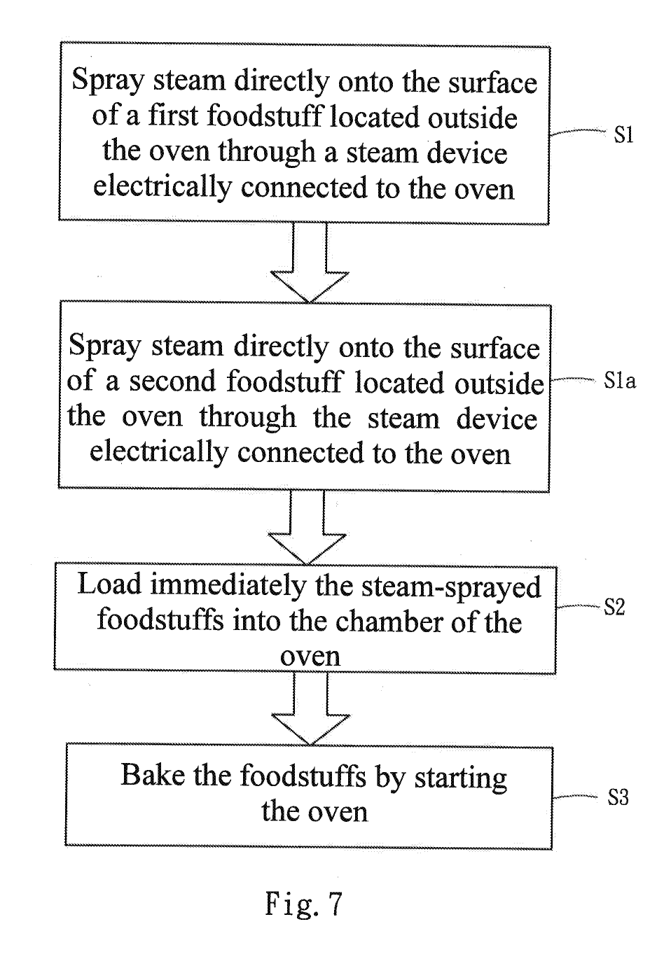

Please refer to FIG. 7 for the flowchart of the baking method provided by the invention when the oven is in use. It comprise the steps as follows: step S1: spraying steam for a first time onto the surface of a first foodstuff located outside the oven through a steam device electrically connected to the oven; step S2: loading immediately the steam-sprayed first foodstuff into the chamber of the oven; and step S3: baking the first foodstuff by starting the oven. The baking method also can further include another step S1a of spraying steam for a second time onto the surface of a second foodstuff located outside the oven through the steam device electrically connected to the oven between the step S1 of spraying steam for a first time and the step S2 of loading the steam-sprayed first foodstuff.

The invention further provides another baking method for the oven of the invention. The method comprises the steps as follows: first, loading a first foodstuff into the chamber of the oven; next, baking the first foodstuff by starting the oven; and then spraying the steam onto the surface of the first foodstuff for at least a set duration through the steam device electrically connected to the oven while the first foodstuff is baked.

The baking method set forth above can further include the steps as follows: spraying the steam onto the surface of a second foodstuff located outside the oven through the steam device electrically connected to the oven; next, loading immediately the steam-sprayed second foodstuff into the chamber of the oven; and baking continuously for a selected duration and spraying the steam onto the surface of the second foodstuff at the same time for at least a set duration through the steam device electrically connected to the oven. There is no time limitation on the selected duration and set duration, but can be adjusted according to user's baking experiences and preferences or baking conditions of the foodstuffs.

1. An oven equipped with a detachable steam device, comprising:
a heat isolation case and a glass door, the heat isolation case including an electric connecting portion at an outer side and a chamber inside;
wherein the steam device includes a body which includes a water reservoir, a heater, a power cord and a steam ejection head; the water reservoir being connected to the heater, the power cord including one end electrically connected to the body and another end electrically connected to the electric connecting portion, the steam ejection head being connected to and communicating with the water reservoir.

2. The oven of claim I, wherein the steam ejection head includes a tube and a nozzle, the tube including one end connected to the nozzle and another end connected to the body.

3. The oven of claim 2, wherein the body includes a fast-coupling connector which holds an annular washer therein, the tube being inserted into the fast-coupling connector to form tight coupling with the annular washer.

4. The oven of claim 3, wherein the tube further includes at least one rigid. section and at least one elastic section.

5. The oven of claim 1, wherein the steam device further includes a handgrip and a power switch.

6. The oven of claim 5, wherein the body further includes an automatic cord winding member inside.

7. A. baking method for the oven of claim 1, comprising the steps of:
spraying steam for a first time onto the surface of a first foodstuff located outside the oven through the steam device electrically connected to the oven;
loading immediately the steam-sprayed first foodstuff into the chamber of the oven; and
baking the first foodstuff by starting the oven.

8. The baking method of claim 7 further including another step of spraying the steam for a second time onto the surface of a second foodstuff located outside the oven through the steam device electrically connected to the oven between the steps of spraying steam for a first time and loading the steam-sprayed first foodstuff.

9. A baking method for the oven of claim 1, comprising the steps of:
loading a first foodstuff into the chamber of the oven;
baking the first foodstuff by starting the oven; and
spraying steam onto the surface of the first foodstuff for a set duration through the steam device electrically connected to the oven while the first foodstuff is baked.

10. The baking method of claim 9 further including the steps of:
spraying the steam onto the surface of a second foodstuff located outside the oven through the steam device electrically connected to the oven;
loading immediately the steam-sprayed second foodstuff into the chamber of the oven; and
baking continuously for a selected duration and spraying the steam onto the surface of the second foodstuff at the same time for at least a set duration through the steam device electrically connected to the oven.
